(19) United States
(12) Patent Application Publication
(10) Pub. No.: US 2007/0251119 A1
(43) Pub. Date: Nov. 1, 2007

(54) Dryer and control method thereof

(75) Inventors: Jae Seok Kim, Changwon-si (KR); Young Jin Doh, Jinhae-si (KR)

Correspondence Address: MCKENNA LONG & ALDRIDGE LLP, 1900 K STREET, NW, WASHINGTON, DC, 20006, US

(73) Assignee: LG ELECTRONICS INC., Youngdungpo-gu (KR)

(21) Appl. No.: 11/785,258

(22) Filed: Apr. 16, 2007

(30) Foreign Application Priority Data
Apr. 17, 2006 (KR) 2006-0034729

(51) Int. Cl. F26B 21/06

(52) U.S. Cl. 34/546; 34/547

(57) ABSTRACT

A dryer and control method thereof are disclosed, by which energy saving and optimal temperature maintenance within a drying drum are enabled in a manner of diversifying a heater temperature by varying a rotational speed of a blowing fan used for the dryer. The present invention includes a drying drum for accommodating an object to be dried therein, a blowing fan provided to enable an air to pass through the drying drum, a heater heating an air supplied to the drying drum, a temperature sensor sensing a temperature within the drying drum, a driving motor generating a driving force to rotate the drying drum and the blowing fan, and a control unit controlling an RPM (revolutions per minute) of the driving motor to be varied according to a sensing result of the temperature sensor.

This application claims the benefit of the Korean Patent Application No. 10-2006-0034729, filed on Apr. 17, 2006, which is hereby incorporated by reference as if fully set forth herein.

### BACKGROUND OF THE INVENTION

1. Field of the Invention

The present invention relates to a dryer for drying a washed laundry and the like, and more particularly, to a dryer and control method thereof. Although the present invention is suitable for a wide scope of applications, it is particularly suitable for maintaining an optimal temperature within a drying drum by varying a rotational speed of a blowing fan used for the dryer.

2. Discussion of the Related Art

Generally, a dryer is provided to dry a wet object (e.g., wet laundry, linen, etc.) to be automatically dried. And, dryers are classified into an exhaust type dryer for drying a laundry by introducing an external air and a condensing type dryer for drying a laundry by removing moisture by circulating an internal air and condensing the removed moisture into water to discharge.

A configuration of the exhaust type dryer according to a related art is schematically explained with reference to the attached drawing as follows.

FIG. 1 is a cross-sectional diagram of an exhaust type dryer according to a related art.

Referring to FIG. 1, an exhaust type dryer according to a related art consists of a body 10, a drying drum 20 rotatably provided within the body 10 to enable a laundry to be dried therein, a drying drum support 60 provided to a front side of the drying drum 20 to rotatably support the drying drum 20, and a driving device for rotating the drying drum 20.

An intake duct 30 is provided to a rear side of the drying drum 20 to guide hot air to an inside of the drying drum 20. In this case, the intake duct 30 is configured to communicate with the drying drum 20. And, a heater 35 is provided within the intake duct 30 to heat the intake air. And, a lint duct 40 provided with a filter 43 is provided under a lower front side of the drying drum 20 to filter off particles such as lint and the like from the air discharged from the drying drum 20.

A blowing fan 45 is provided to one side of the lint duct 40 to force air sucked via the lint duct 40 to be blown to an exhaust duct 15. In this case, the blowing fan 45 is provided within a blowing fan housing 44 configured to communicate with the lint duct 40.

The driving device includes a driving motor 50 for driving both of the blowing fan 35 and the drying drum 20 simultaneously, a pulley 53 provided to one side of the driving motor 50, and a belt 55 connected to an outer circumference of the drying drum 20 to transfer a rotational power thereto.

The blowing fan 45 is connected to a driving shaft (not shown in the drawing) of the driving motor 50 extending in a direction opposite to the pulley 53 to be driven together in case of driving the driving motor 50.

In the above-configured exhaust type dryer, as the driving motor 50 is activated, the drying drum 20 connected to the driving motor 50 via the belt 55 is rotated simultaneously together with the blowing fan 45.

As the blowing fan 35 is activated, an external air is introduced into the intake duct 30. The external air is heated in passing through the heater 35. The heated air is then introduced into the drying drum 20.

The hot air introduced into the drying drum 20 enables a wet object to be dried by evaporating the moisture from the object and then turns into a low-temperature and high-humid air. The low-temperature and high-humid air is then externally discharged via the lint duct 40, the blowing fan housing 44, and the exhaust duct 15.

In a heater controlling method in the related art dryer, a pair of heaters 35 having capacities equal to or different from each other are simultaneously driven or one of the heaters 35 is driven only. This corresponds to a 2-step control method.

In particular, the operation control of the heaters 35 is carried out by repeating a process for turning on both of the heaters 35 simultaneously for a prescribed time and turning on one of the heaters 35 only for another prescribed time in a manner of turning of the other.

However, in the related art, a pair of the heaters 35 having the same capacity are controlled by the s-step control, whereby it is difficult to maintain an appropriate temperature within the drying drum 20. And, considerable power consumption is unnecessarily required.

Moreover, in case of performing the drying process by simultaneously driving a pair of the heaters 35, i.e., in case of a hot drying, texture is damaged by hot temperature. In case of performing the drying process by driving one of the heaters 35 only, i.e., in case of a cool drying, a drying time increases.

### SUMMARY OF THE INVENTION

Accordingly, the present invention is directed to a dryer and control method thereof that substantially obviate one or more problems due to limitations and disadvantages of the related art.

An object of the present invention is to provide a dryer and control method thereof, by which energy saving and optimal temperature maintenance within a drying drum are enabled in a manner of diversifying a heater temperature by varying a rotational speed of a blowing fan used for the dryer.

Another object of the present invention is to provide a dryer and control method thereof, by which drying efficiency can be enhanced.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dryer according to the present invention includes a drying drum for accommodating an object to be dried therein, a blowing fan provided to enable an air to pass through the drying drum, a heater heating an air supplied to the drying drum, a temperature sensor sensing a temperature within the drying drum, a driving motor generating a driving force to rotate the drying drum and the blowing fan, and a control unit controlling an RPM (revolutions per minute) of the driving motor to be varied according to a sensing result of the temperature sensor.

Preferably, the driving motor includes a BLAC motor.

Preferably, the RPM of the driving motor is variable according to a frequency of a power applied to the driving motor.

In another aspect of the present invention, a method of controlling a dryer includes a step (A) of sensing a temperature within a drying drum to compare the sensed temperature to a preset temperature and a step (B) of adjusting a temperature of a hot air passing through a heater by selectively controlling an RPM of a blowing fan having the RPM varied by a driving motor according to a sensing result of the step (A).

Preferably, in the step (B), according to the sensing result of the step (A), if the temperature within the drying drum stays within the preset temperature range, the RPM of the blowing fan is maintained at a preset RPM to keep the temperature of the hot air passing through the heater.

Preferably, in the step (B), according to the sensing result of the step (A), if the temperature within the drying drum is equal to or greater than the preset temperature range, the RPM of the blowing fan is raised to lower the temperature of the hot air passing through the heater.

Preferably, in the step (B), according to the sensing result of the step (A), if the temperature within the drying drum is smaller than the preset temperature range, the RPM of the blowing fan is lowered to raise the temperature of the hot air passing through the heater.

Preferably, the RPM of the blowing fan is maintained, raised, or lowered by controlling a rotational speed of the driving motor connected to the blowing fan.

More preferably, the rotational speed of the driving motor is adjusted by a frequency (Hz) control.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional diagram of an exhaust type dryer according to a related art;

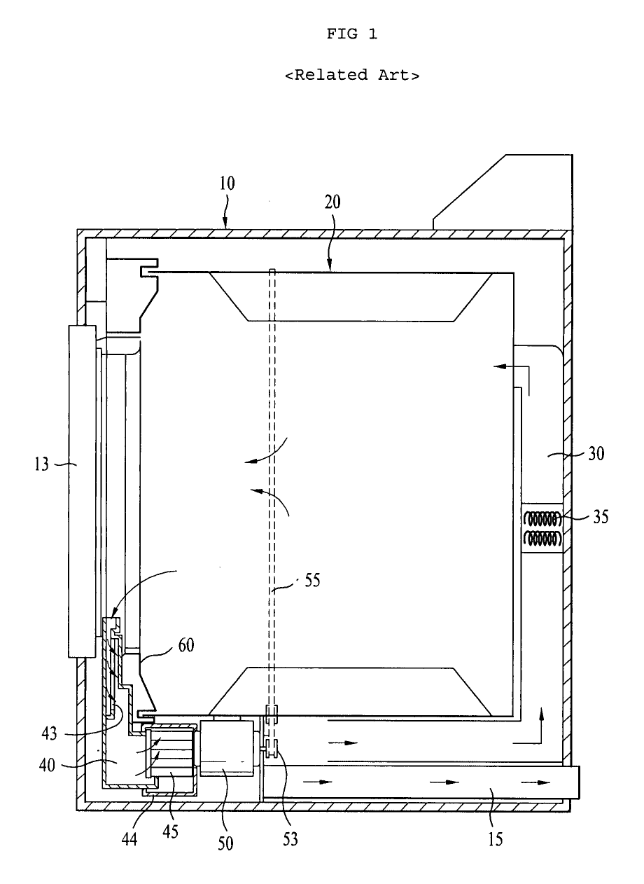

FIG. 2 is a cross-sectional diagram of an exhaust type dryer according to an embodiment of the present invention;

FIG. 3 is a block diagram of elements for a method of controlling a dryer according to an embodiment of the present invention; and

FIG. 4 is a flowchart of a method of controlling a dryer according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

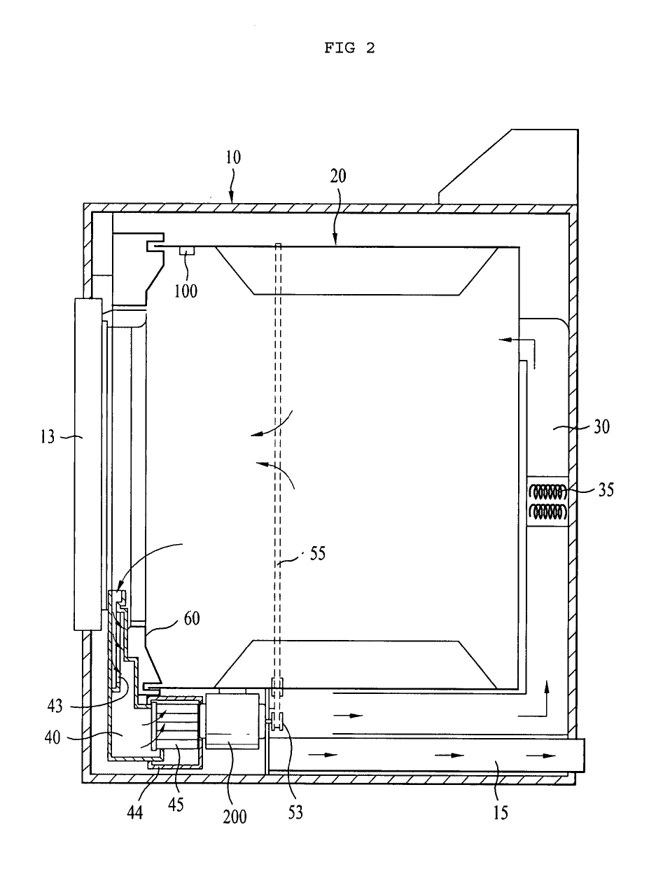

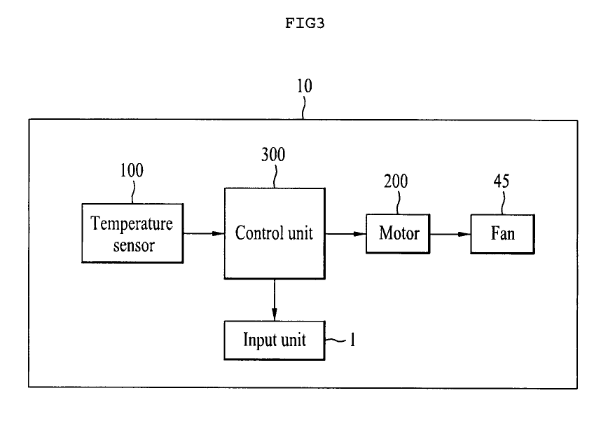

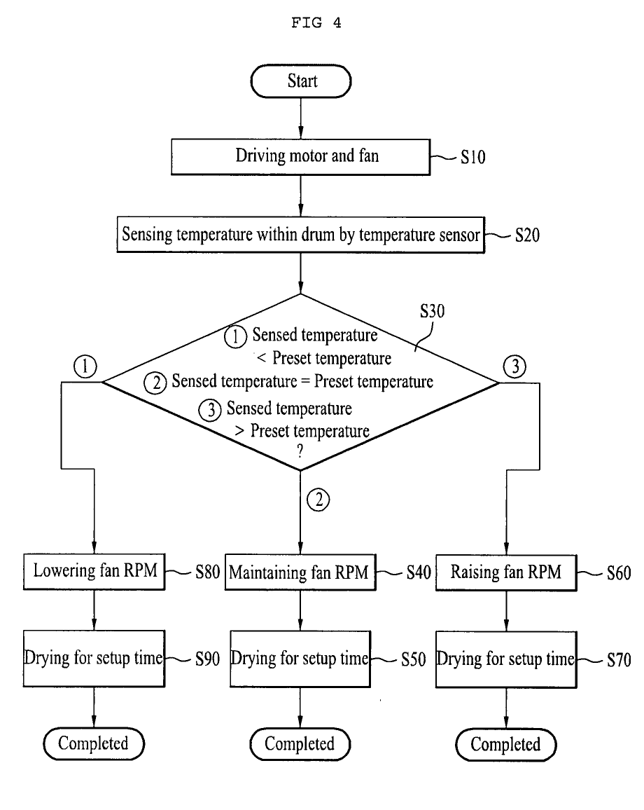

FIG. 2 is a cross-sectional diagram of an exhaust type dryer according to an embodiment of the present invention, FIG. 3 is a block diagram of elements for a method of controlling a dryer according to an embodiment of the present invention, and FIG. 4 is a flowchart of a method of controlling a dryer according to the present invention.

Referring to FIG. 2 and FIG. 3, a dryer according to an embodiment of the present invention includes a drying drum 20 for accommodating an object to be dried therein, a blowing fan 45 provided to enable an air to pass through the drying drum 20, a heater 35 heating an air supplied to the drying drum 20, a temperature sensor 100 sensing a temperature within the drying drum 20, a driving motor 200 generating a driving force to rotate the drying drum 20 and the blowing fan 45, and a control unit 300 controlling an RPM (revolutions per minute) of the driving motor 200 to be varied according to a sensing result of the temperature sensor 100.

An intake duct 30 is provided to a rear side of the drying drum 20 to guide hot air to an inside of the drying drum 20. In this case, the intake duct 30 is configured to communicate with the drying drum 20. And, a heater 35 is provided within the intake duct 30 to heat the intake air. And, a lint duct 40 provided with a filter 43 is provided under a lower front side of the drying drum 20 to filter off particles such as lint and the like from the air discharged from the drying drum 20.

A blowing fan 45 is provided to one side of the lint duct 40 to force air sucked via the lint duct 40 to be blown to an exhaust duct 15. In this case, the blowing fan 45 is provided within a blowing fan housing 44 configured to communicate with the lint duct 40.

The blowing fan 45 is connected to a driving shaft (not shown in the drawing) of the driving motor 200 extending in a direction opposite to a pulley 53 of the driving motor 200 to be driven together in case of driving the driving motor 200.

The exhaust duct 15 is configured to have one end portion communicate with an external environment of the body 10. So, the exhaust duct 15 plays a role in leading the air forced to be blown from the lint duct 40 by the blowing fan 45 to the external environment of the dryer.

Meanwhile, a door 13 is provided to a front side of the body 10 to open/close the drying drum 20 for loading/unloading an object to be dried.

The driving motor of the present invention preferably includes a BLAC motor capable of varying the RPM of the drying drum 20 and the RPM of the blowing fan 45.

This is to raise or lower a temperature of the hot air supplied to the drying drum via the heater 35 in a manner of varying a rotational speed of the blowing fan 45 according to the temperature, which is sensed by the temperature sensor 100, within the drying drum 20.

For instance, as a sensing result by the temperature sensor 100, if the temperature within the drying drum 20 is higher than a preset temperature range, the RPM of the driving motor 200 is raised via the control unit 300 to raise the RPM of the blowing fan 45.

In this case, the air forced to flow by the blowing fan 45 passes trough the heater 35 fast to reduce a time taken to keep contacting with the heater 35. So, the temperature of the hot air supplied to the drying drum 20 is lowered.

On the other hand, if the temperature within the drying drum 20 is lower than a preset temperature range, the RPM of the driving motor 200 is lowered via the control unit 300 to lower the RPM of the blowing fan 45.

In this case, the air forced to flow by the blowing fan 45 passes trough the heater 35 slow to increase a time taken to keep contacting with the heater 35. So, the temperature of the hot air supplied to the drying drum 20 is raised.

Meanwhile, the driving motor RPM control can be achieved by a frequency (Hz) control.

For instance, in case that the blowing fan 45 is driven by applying a power of frequency 60 Hz using the driving motor 200 to keep a preset temperature range between 100˜110° C. within the drying drum 20 in the course of a drying process, if a temperature within the drying drum 20 is equal to or greater than a preset temperature, the RPM of the driving motor 200 is raised by applying a power having a frequency equal to or greater than 60 Hz to the driving motor 200. If so, the RPM of the blowing fan 45 connected to the driving motor 200 is raised.

On the other hand, if a temperature within the drying drum 20 is smaller than a preset temperature, the RPM of the driving motor 200 is lowered by applying a power having a frequency smaller than 60 Hz to the driving motor 200. If so, the RPM of the blowing fan 45 connected to the driving motor 200 is lowered.

As mentioned in the foregoing description, a method of controlling the above-configured dryer can include a step (A) of sensing a temperature within the drying drum and then comparing the sensed temperature to a preset temperature and a step (B) of adjusting a temperature of a hot air passing through the heater by selectively controlling the RPM of the blowing fan according to a sensing result of the step (A).

A method of controlling a dryer according to an embodiment of the present invention is explained with reference to FIG. 4 as follows.

Referring to FIG. 4, a specific drying course is selected via the key input unit 1 and an operation start command is then inputted. If so, the control unit 300 receives the selection and command and then outputs a control signal to drive the dryer according to the condition selected by a user. According to the control signal outputted by the control unit 300, the driving motor 200 is driven to rotate the drying drum 20 and the blowing fan 45 while the heater 35 is driven to generate a hot air (S10).

Subsequently, while the drying course is in progress, a temperature within the drying drum 20 is sensed by the temperature sensor 100 provided to the drying drum 20. The sensed temperature is then compared to a preset temperature range, e.g., a temperature range between 100˜110° C. (S20, S30).

According to a result of sensing the temperature within the drying drum 20, the RPM of the blowing fan 45 is adjusted to maintain, raise or lower a temperature of the hot air flowing through the heater 35.

First of all, according to a result of sensing the temperature within the drying drum 20, if the temperature within the drying drum 20 stays within the preset temperature range, the RPM of the blowing fan 45 is maintained as the preset RPM to keep the temperature of the hot air flowing through the heater 35. And, the drying course keeps being performed for a setup time to be completed (S40, S50).

Secondly, according to a result of sensing the temperature within the drying drum 20, if the temperature within the drying drum 20 is equal to or greater than the preset temperature range, the RPM of the blowing fan 45 is raised by raising the RPM of the driving motor 200 to lower the temperature of the hot air flowing through the heater 35 (S60).

Thereafter, if the temperature within the drying drum 20 stays within the preset temperature range by adjusting the RPM of the blowing fan 45, the drying course keeps being performed for a setup time to be completed (S70).

Thirdly, according to a result of sensing the temperature within the drying drum 20, if the temperature within the drying drum 20 is smaller than the preset temperature range, the RPM of the blowing fan 45 is lowered by lowering the RPM of the driving motor 200 to raise the temperature of the hot air flowing through the heater 35 (S80).

Thereafter, if the temperature within the drying drum 20 stays within the preset temperature range by adjusting the RPM of the blowing fan 45, the drying course keeps being performed for a setup time to be completed (S90).

As mentioned in the foregoing description, the temperature within the drying drum 20 can be maintained at the preset temperature by varying the RPM of the blowing fan 45, whereby drying efficiency can be enhanced.

Accordingly, the present invention provides the following effects or advantages.

First of all, the present invention varies an RPM of a driving motor to control an RPM of a blower fan in the course of performing a drying course. So, a temperature of hot air flowing through a heater can be operationally varied to enable a temperature within a drying drum to be optimally maintained.

Secondly, the present invention enhances drying efficiency.

Thirdly, by maintaining a temperature within a drying drum at a preset temperature, the present invention prevents texture or cloth from damaged at high temperature.

Fourthly, the present invention prevents energy efficiency from decreasing by increasing a drying time at low temperature.

It will be apparent to those skilled in the art that various modifications and variations can be made in the present invention without departing from the spirit or scope of the inventions. Thus, it is intended that the present invention cover the modifications and variations of this invention provided they come within the scope of the appended claims and their equivalents.

1. A dryer comprising:
a drying drum for accommodating an object to be dried therein;
a blowing fan provided to enable an air to pass through the drying drum;
a heater heating an air supplied to the drying drum;
a temperature sensor sensing a temperature within the drying drum;
a driving motor generating a driving force to rotate the drying drum and the blowing fan; and
a control unit controlling an RPM (revolutions per minute) of the driving motor to be varied according to a sensing result of the temperature sensor.

2. The dryer of claim 1, wherein the driving motor comprises a BLAC motor.

3. The dryer of claim 1, wherein the RPM of the driving motor is variable according to a frequency of a power applied to the driving motor.

4. A method of controlling a dryer, comprising:
a step (A) of sensing a temperature within a drying drum to compare the sensed temperature to a preset temperature; and
a step (B) of adjusting a temperature of a hot air passing through a heater by selectively controlling an RPM of a blowing fan having the RPM varied by a driving motor according to a sensing result of the step (A).

5. The method of claim 4, wherein in the step (B), according to the sensing result of the step (A), if the temperature within the drying drum stays within the preset temperature range, the RPM of the blowing fan is maintained at a preset RPM to keep the temperature of the hot air passing through the heater.

6. The method of claim 4, wherein in the step (B), according to the sensing result of the step (A), if the temperature within the drying drum is equal to or greater than the preset temperature range, the RPM of the blowing fan is raised to lower the temperature of the hot air passing through the heater.

7. The method of claim 4, wherein in the step (B), according to the sensing result of the step (A), if the temperature within the drying drum is smaller than the preset temperature range, the RPM of the blowing fan is lowered to raise the temperature of the hot air passing through the heater.

8. The method of claim 5, wherein the RPM of the blowing fan is maintained by controlling a rotational speed of the driving motor connected to the blowing fan.

9. The method of claim 8, wherein the rotational speed of the driving motor is adjusted by a frequency (Hz) control.

10. The method of claim 6, wherein the RPM of the blowing fan is raised by controlling a rotational speed of the driving motor connected to the blowing fan.

11. The method of claim 7, wherein the RPM of the blowing fan is lowered by controlling a rotational speed of the driving motor connected to the blowing fan.
